(19) United States
(12) Patent Application Publication
(10) Pub. No.: US 2025/0122813 A1
(43) Pub. Date: Apr. 17, 2025

(54) METHOD FOR MANUFACTURING A CASING FOR AN AIRCRAFT TURBINE ENGINE

(71) Applicant: SAFRAN AIRCRAFT ENGINES, Paris (FR)

(72) Inventors: Vincent Pascal FIORE, MOISSY-CRAMAYEL (FR); Clément BOUROLLEAU, MOISSY-CRAMAYEL (FR); Alexandre BRANCO, MOISSY-CRAMAYEL (FR); Serge Emmanuel DOMINGUES, MOISSY-CRAMAYEL (FR)

(73) Assignee: SAFRAN AIRCRAFT ENGINES, Paris (FR)

(21) Appl. No.: 18/692,544

(22) PCT Filed: Sep. 14, 2022
(86) PCT No.: PCT/FR2022/051728

§ 371 Date: Mar. 15, 2024

(30) Foreign Application Priority Data
Sep. 15, 2021 (FR) FR2109701

(51) Int. Cl. F01D 25/24

(52) U.S. Cl. CPC F01D 25/24; F05D 2230/50; F05D 2230/64; F05D 2300/603

(57) ABSTRACT

A method for producing casing for an aircraft turbine engine includes a first step of manufacturing an annular shell having an axis A made of a composite material in a mold that includes an annular cavity that receives the preform. A resin is injected into the cavity and subsequently polymerized. During a second step, at least one axial abutment means is arranged inside the shell, and during a third step, the annular cartridge made of an abradable material is arranged inside the annular shell in contact with the axial abutment means. A fourth step includes bonding the annular cartridge to the first inner annular surface. The first and second steps are simultaneous, and the at least one axial abutment means is molded with the preform in the mold.

### TECHNICAL FIELD OF THE INVENTION

This invention relates to the manufacture of a casing, in particular of a fan, for an aircraft turbine engine.

### TECHNICAL BACKGROUND

The prior art comprises in particular, the documents FR-A1-2 997 725, FR-A1-2 997 726, FR-A1-3 005 100, US-A1-2014/367 290 and FR-A1-3 037 854.

In a known way, a double or triple body turbine engine comprises, from upstream to downstream, i.e., in the direction of flow of the gas streams, a fan, at least one low-pressure compressor, a high-pressure compressor, a combustion chamber, a high-pressure turbine, at least one low-pressure turbine, and an exhaust nozzle of the combustion gases leaving the turbines. A rotor of the high-pressure compressor is connected to a rotor of the high-pressure turbine by a high-pressure shaft, and these rotors form a high-pressure body. At least one rotor of a low-pressure compressor is connected to a rotor of a low-pressure turbine by a low-pressure shaft, and these rotors thus form at least one low-pressure body. The low-pressure shaft passes coaxially through the high-pressure shaft and drives a rotor of the fan, either directly or via a reducer.

The fan comprises a bladed wheel surrounded by a fan casing, also known as a retention casing, because of its function of retaining the vanes in the event of their breakage, or in the event of debris entering the fan. Such a casing is composed of an axial annular envelope which extends around the fan blades of the turbine engine and which comprises an upstream annular section carrying upstream acoustic panels on the inside, a downstream section carrying downstream acoustic panels on the inside, and an intermediate section, arranged axially between the upstream and downstream sections, comprising a first internal annular surface to which is attached an annular cartridge of abradable material, made in one piece or sectorized. The fan casing is connected upstream to an air inlet sleeve downstream, to a shroud of an intermediate casing of the turbine engine.

In addition to its retention function, the fan casing ensures the continuity of the aerodynamic vein via the annular cartridge made of abradable material. It also ensures a mechanical continuity of forces and moments between the air inlet sleeve and the shroud of the intermediate casing. It can also be used to fix various items of equipment and supports, to ensure compliance with fire and leakage regulations, and to ensure continuity of electrical current to withstand lightning strikes on the turbine engine.

The annular cartridge of abradable material is made, for example, in the form of a shroud produced by injection molding or in the form of an assembly of sectors.

The annular cartridge is conventionally immobilized axially with respect to the envelope so that it coincides axially with the intermediate section of the envelope provided for this purpose. To do this, the intermediate section of the envelope conventionally comprises, at least one of its ends, a series of axial abutments which are fixed to an inner circumference of the envelope, to receive the annular cartridge in abutment, in order to define its position.

The annular cartridge is then flanged in the envelope and subjected to a bonding step on the first internal annular surface, during which the casing is heated and held and compressed by means of a removable system arranged at least partly inside the casing. Thanks to the removable system, a mechanical pressure force is applied to the annular cartridge, enabling the annular cartridge to be held in position during the heating step. The bonding is carried out in an autoclave.

Conventionally, the axial abutments are attached to the envelope. For example, the envelope receives skids each having a longitudinal portion extending along the first internal annular surface and a transverse portion extending perpendicular to the longitudinal portion and forming an axial abutment. The longitudinal portion comprises bores that are intended to be crossed with screws allowing the attachment of each skid to the envelope.

This technical solution requires a preliminary bore of the envelope according to a rigorous positioning, and then each of the skids to be mounted, which increases the cost of manufacturing such a casing.

There is therefore a need for a casing for a turbine engine equipped with one or more axial abutments means of simple embodiment that do not require complex mounting operations.

### SUMMARY OF THE INVENTION

The invention responds to this need by proposing a method for manufacturing a casing for a turbine engine comprising one or more axial abutment means integrated directly into the envelope during its manufacture.

To this end, the invention proposes a method for manufacturing a casing for an aircraft turbine engine, comprising at least:
a first step of manufacturing an annular envelope extending around an axis A and comprising at least one intermediate section intended to receive an annular cartridge made of an abradable material, during which an annular preform of axis A of the envelope, made of a composite material comprising 3-dimensional woven fibres, is placed in a mold which comprises an annular cavity for complementarily receiving the preform, then during which a resin is injected into said cavity, and the resin is subsequently polymerised,
a second step during which at least one axial abutment means is arranged projecting from a first internal annular surface of the intermediate section of the envelope, at a first end of said intermediate section,
a third step during which the annular cartridge made of an abradable material is arranged inside the annular envelope in contact with said axial abutment means, covering said first annular surface,
a fourth step of bonding the annular cartridge made of abradable material on the first internal annular surface, during which the casing is heated and held by means of a system present at least in part inside the casing,
characterised in that the second step takes place simultaneously with the first step and in that, during said second step, said at least one axial abutment means is molded with the preform in the mold.

This embodiment allows us to produce an envelope of casing in which the abutment means are integrated into the envelope during its manufacture, with the advantage of not requiring costly and time-consuming operations after the envelope has been manufactured.

According to other characteristics of the method:
the axial abutment means molded with the preform is in the form of an annular bead of axis A,
the mold used during said first and second steps comprises an outer annular shell of axis A and an inner annular shell of axis A between which the cavity is delimited, and the inner shell comprises an annular groove of axis A which opens into the cavity and which is capable of being filled with resin when it is injected into the cavity, in order to form said bead after the polymerisation of the resin and demolding,
the third step, during which the annular cartridge made of an abradable material is flanged inside the envelope by means of at least one removable flanging device.

The invention also relates to an annular envelope of axis A of a casing for a turbine engine molded by resin injection from an annular preform made of 3-dimensional woven fibres, characterised in that it comprises at least one annular intermediate section which is intended to receive an annular cartridge made of an abradable material and a first internal annular surface of which comprises at least one axial abutment means which projects from said first internal annular surface and which is molded with the resin of said envelope.

Other characteristics of the envelope include:
the axial abutment means is an annular bead of axis A molded with the resin of the envelope,
the axial abutment means is an annular bead of axis A made entirely and solely from the resin of the envelope,
the bead has a thickness or radial dimension of between 10 and 30 mm and/or a width or axial dimension of between 2 and 3 mm.

The invention also relates to a mold for manufacturing of an annular envelope of a casing for a turbine engine of the type described above, characterised in that it comprises an outer annular shell of axis A with an inner annular recess and an inner annular shell of axis A with an outer annular recess, said recesses delimiting a cavity of the mold, said shells being capable of being arranged respectively outside and inside the preform so that the cavity receives a preform and is filled with resin by injection, characterized in that an intermediate section of the inner shell comprises an annular groove of axis A formed in the outer annular recess and capable of being filled with resin.

Finally, the invention relates to a dual-flow aircraft turbine engine comprising a fan casing of the type described above.

### BRIEF DESCRIPTION OF THE FIGURES

Further characteristics and advantages of the invention will become apparent from the following detailed description, for the understanding of which reference is made to the attached drawings in which:

FIG. 1 is a cross-sectional view of a fan of an aircraft turbine engine;

FIG. 2 shows a perspective view of a fan casing according to the prior art;

FIG. 3 shows a schematic partial cross-section of a fan casing according to the prior art;

FIG. 4 is a perspective view of a fan casing in a state of holding an annular cartridge made of an abradable material, in which the annular cartridge is sandwiched between two series of skids, during a step of bonding thereof;

FIG. 5 is an enlargement of a detail of FIG. 5 showing a skid a part of the annular cartridge;

FIG. 6 is a cutaway perspective view of an envelope of a fan casing according to the invention;

FIG. 7 is a perspective view illustrating the bonding of an annular cartridge made of abradable material into an envelope of a fan casing according to the invention;

FIG. 8 is a schematic cross-sectional view of the principle of a mold for manufacturing an annular envelope of a casing for a turbine engine according to the invention.

FIG. 9 is a block diagram illustrating the manufacturing steps of a casing according to the invention.

### DETAILED DESCRIPTION OF THE INVENTION

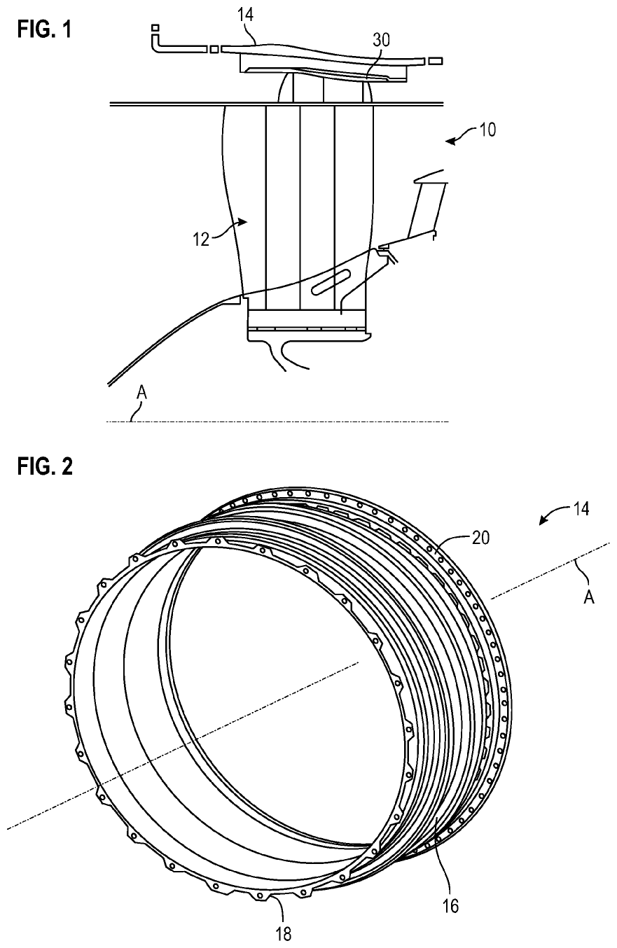

FIG. 1 shows a partial view of a fan 10 of an aircraft turbine engine.

In a known way, a double or triple body turbine engine comprises, from upstream to downstream, i.e., in the direction of flow of the gas streams, a fan, at least one low-pressure compressor, a high-pressure compressor, a combustion chamber, a high-pressure turbine, at least one low-pressure turbine, and an ejection nozzle of the combustion gases leaving the turbines. A rotor of the high-pressure compressor is connected to a rotor of the high-pressure turbine by a high-pressure shaft, thus forming a high-pressure body. At least one rotor of a low-pressure compressor is connected to a rotor of a low-pressure turbine by a low-pressure shaft, thus forming at least one low-pressure body. The low-pressure shaft passes coaxially through the high-pressure shaft and drives a rotor of the fan, either directly or via a reducer.

The fan 10 comprises a bladed wheel 12 which is surrounded by a fan casing 14, also known as a retention casing because of its function of retaining the vanes in the event of their breakage, or in the event of debris entering the fan.

In the remainder of this description, the invention is applied to a fan casing 14. However, the invention is not limited to this type of casing and can be applied to other casings of a turbine engine.

As can be seen more particularly in FIG. 2, the fan casing 14 comprises an annular envelope 16 of axis of revolution A which extends around the fan blades 12 of the turbine engine referred to above. This envelope comprises an annular fixing flange 18, 20 at each of its axial ends. These flanges 18, 20 are used to attach the casing 14 to annular walls of the nacelle of the turbine engine.

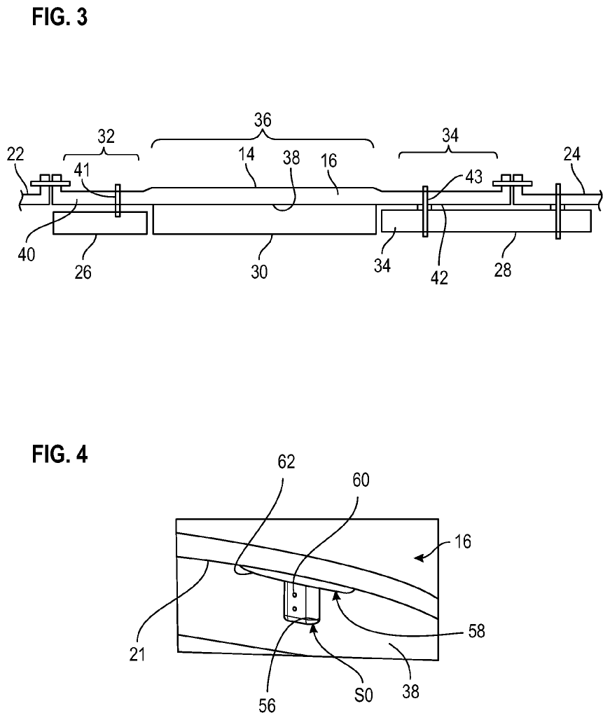

As illustrated more particularly in the schematic section of FIG. 3, the fan casing 14 is connected upstream to an air inlet sleeve 22 and downstream to an intermediate casing shroud 24. The casing 14 also has upstream acoustic panels 26 and downstream acoustic panels 28. The fan casing 14 also comprises an annular cartridge 30 made of abradable material, positioned on an inner annular surface of the envelope, between the upstream panels 26 and the downstream panels 28.

This cartridge 30 can be made either in the form of an annular shroud, or in the form of panels forming angular sectors of shroud, which are assembled to one another.

As we have seen, the casing 14 comprises an annular envelope 16 extending around the axis A, which is made from a composite material comprising woven fibres embedded in a resin. The envelope 16 comprises an upstream section 32, suitable for receiving the upstream acoustic panel 26, a downstream section 34, suitable for receiving the downstream acoustic panel 26, and an intermediate section 36, suitable for receiving the cartridge 30 made of abradable material.

The annular cartridge 30 covers a first internal annular surface 38 of the intermediate section 36, while the upstream acoustic panel 26 is fixed to a second internal annular surface 40 of the upstream section 3,2 for example using screwing means 41, and the downstream acoustic panel 26 is attached to a third internal annular surface 42 of the downstream section 34, for example using screwing means 43.

The annular cartridge 30 is designed to be attached by bonding to the first internal surface 38 of the envelope 16.

To do this, the cartridge 30 is uniquely positioned axially in the envelope 14, then immobilised therein. This is followed by a bonding step, during which the casing 14 is subjected to heat treatment under pressure.

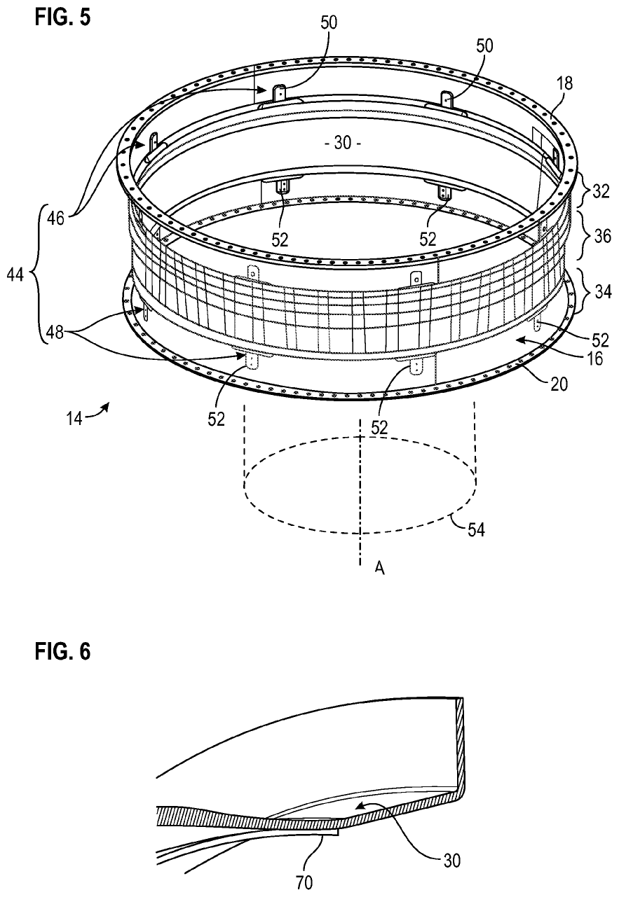

FIG. 5 shows a casing 14 provided with a tooling 44 according to a prior art method for immobilizing the casing 14 in the intermediate section 36 of the envelope 16. This tooling 44 consists of two series 46, 48 of skids 50, 52. With the exception of the members (studs, pins, fasteners, etc.) used to hold the skids 50, 52 and possibly attach them to the casing 3, the tooling 44 does not comprise any other parts and is therefore relatively simple.

In practice, during the bonding operation, and more specifically during the heating operation, the casing 14 is placed in an autoclave (not shown) so that its axis A is oriented vertically.

A pressurisation system 54 can be fitted inside the casing 14, this system 54 being shown schematically in FIG. 5. This system 54 occupies part of the internal space of the casing 14 and the tooling 44 is designed to take account of this constraint.

The skids 50, 52 allow the cartridge 30 to be axially immobilized in the intermediate section 36, forming axial abutment means.

In the example shown here, the tooling 44 comprises two series 46, 48 of skids 50, 52 forming axial abutments, but this configuration is not restrictive of the invention, and the tooling could comprise only one series 46 or 48 of skids 50 or 52 to receive a first end of the cartridge 30 as a abutment, the latter being immobilised axially in another way at its second opposite end.

FIG. 4 shows a detail of a skid 50 forming an axial abutment known in the prior art.

The skid 50 comprises a longitudinal portion 56 and a transverse portion 58. The longitudinal portion 56 is designed to be mounted in a removable manner against the envelope 16 and more precisely against the respective first internal annular surface 38 of the intermediate section 36 designed to receive the cartridge 30 made of abradable material, at one end of this section 36. To do this, the longitudinal portion 56 comprises at least one bore 60 through which a fastening means (not shown), such as a screw, pin, fastener, etc., can pass and which is received in the intermediate section 36.

The transverse portion 58 is designed to extend transversely to the longitudinal portion 56. The transverse portion 58 has a contact surface 62 designed to receive and bear against the cartridge 30 made of abradable material. The skid 50 can be made in two parts, the longitudinal portion 56 being positioned in contact with the respective first internal annular surface 38 of the intermediate section 36 and fixed by means of the aforementioned screws, before the transverse portion 58 is mounted on the longitudinal portion 56.

Each series 46, 48 of skids 50, 52 comprises between 4 and 20 skids distributed evenly, i.e., equidistantly, around the periphery of the end of the intermediate section 36 of the envelope. The bearing load of the cartridge 30 is thus distributed evenly around the circumference.

A method for manufacturing a casing 14 according to the prior art comprises a first step of manufacturing the annular envelope 16, during which an annular preform of axis A of the envelope is placed, made of a composite material comprising 3-dimensional woven fibres, in a mold which comprises an annular cavity for complementarily receiving the preform, then during which a resin is injected into said cavity and the resin is subsequently polymerised. As this embodiment has been extensively documented by the prior art, it is cited here only for the record and will not be the subject of a broader description.

Then, during a second step, a first series 48 of skids 52 forming as many axial abutment means is arranged projecting from the first internal annular surface 38 of the intermediate section 36 of the envelope 16, at a first end of said intermediate section 36.

Then, in a third step, the annular cartridge 30 made of abradable material is placed inside the annular envelope 16 in contact with the skids 52, covering the first annular surface 38. A second series 46 of skids 50 are then arranged, forming axial abutment means projecting from the first internal annular surface 38 of the intermediate section 36 of the envelope 16, at a second end of the intermediate section 36.

Then, in a fourth bonding step, the annular cartridge 30 made of abradable material is bonded to the first internal annular surface 38. During this step, the casing 16 is heated and maintained by means of a system present at least in part inside the casing. In particular, this system comprises the pressurisation system 54 which urges the cartridge 30 into contact with the envelope 16.

Overall, this configuration is satisfactory, but it requires on the one hand the operations to prepare the envelope 16 and on the other hand the operations to position and mount the skids 50, 52, which increases the total cost of manufacturing the casing 14.

The invention remedies this disadvantage by proposing a method for manufacturing a casing 14 for the turbine engine incorporating one or more axial abutment means directly integrated into the envelope 16 during its manufacture.

As previously, and as illustrated in FIG. 9, the method for manufacturing the casing 14 according to the invention comprises a first step ET1 of manufacturing an annular envelope extending around an axis A and comprising at least one intermediate section 36 similar to that previously described, which is intended to receive an annular cartridge 30 made of an abradable material similar to that previously described.

During this step ET1, as illustrated in FIG. 9, an annular preform 66 of axis A of the envelope 30, made of composite material and comprising 3-dimensional woven fibres, is placed in a mold 64 which comprises an annular cavity 68 for complementarily receiving the preform 64, then a resin is injected into this cavity, and the resin is subsequently polymerised.

Then, similarly to the method used in the art, in a second step ET2, at least one axial abutment means 70 is arranged projecting from the first internal annular surface 38 of the intermediate section of the envelope 36, at a first end of this intermediate section.

The difference between the method covered by the invention and the method according to the prior art lies in the fact that, according to the invention, the second step ET2 takes place simultaneously with the first step ET1 and in that, during this second step ET2, this axial abutment means 70 is molded with the preform 66 in the mold 64.

The axial abutment means 70 molded with the preform 66 can take different forms. It may initially consist of a skid substantially similar to the skids 52 previously described, which would not be fixed to the envelope but overmolded in the resin with the preform 66 so as to be integrated into the envelope.

However, preferably, as shown in FIG. 6, during this second step ET2 the axial abutment means 70 molded with the preform to form the envelope 30 is in the form of an annular bead of axis A.

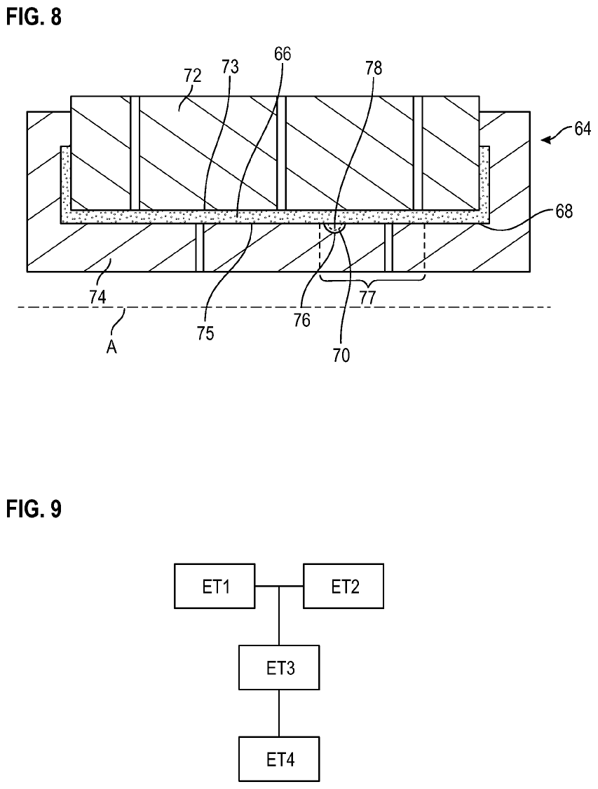

In its simplest form, the axial abutment means 70 is an annular bead which could be obtained from an annular ring 78 received with the preform 66 in the mold 64. To this end, as shown in FIG. 8, the mold 64 used in the first and second steps comprises an outer annular shell 72 of axis A with an inner recess 73 and an inner annular shell 74 of axis A with an outer recess 75. The cavity 68 is delimited between the shells 72, 74 and more particularly by the recesses 73, 75. The inner shell 74 comprises an annular groove 76 of axis A which opens into the cavity 68 and which is able to review before the injection of resin the ring 78, shown here in dotted lines.

More particularly, an intermediate section 77 of the inner shell comprises the annular groove 76 of axis A formed in the outer annular recess which can be filled with resin, and this section 77 defines the counter-form of the intermediate section 36 of the envelope 16 which is designed to receive the cartridge 30.

The bead 70 is therefore the result of overmolding the ring 78 with the preform 66 with the resin of the envelope 30, and the ring 78 is therefore covered with resin in the groove 76.

However, according to a preferred embodiment of the invention, the groove 76 is only intended to be filled with resin when it is injected into the cavity, to form said bead 70 after the resin has polymerised and demolded. In this case, the groove 76 does not receive a ring before the resin is injected and the axial abutment means 70 is an annular bead of axis A made entirely and solely from the resin of the envelope 30.

In these last two embodiments, as the envelope 16 is oriented vertically for bonding the cartridge 30, it is understood that the final dimensions of the bead 70 are designed to support the weight of the cartridge 30.

By way of example, the bead 70 typically has a radial thickness or dimension of between 10 and 30 mm and/or an axial width or dimension along axis A of between 2 and 3 mm.

It will therefore also be understood in both embodiments that to obtain a bead 70 capable of supporting the weight of the cartridge 30, the dimensions of the groove 76 must be calculated judiciously, and in particular for the latter embodiment in which the volume of the groove must be provided to generate an annular cord of resin of sufficient strength.

Similar to the method according to the prior art, the method comprises a third step ET3 during which the annular cartridge 30 made of abradable material is placed inside the annular envelope 16 in contact with the axial abutment means 70, covering said first annular surface 38.

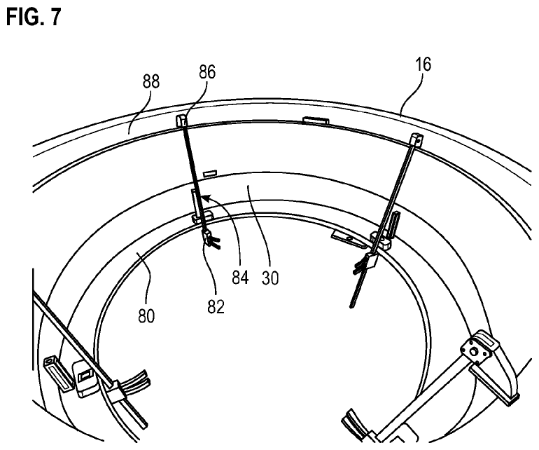

This configuration is shown in FIG. 7. Unlike the prior art method, there is no pressurisation system mounted inside the casing 14. As the cartridge 30 is received in abutment in the envelope 16, during a step ET4, it is held in place with a removable flanging device. To do this, an annular disk 80 is placed under the envelope 16, bearing on the end of the envelope 16. This disk 80 allows to receive first grip faces 82 of screw clamp 84 which pass through the cartridge 30 and second grip faces 86 of which clamp the second end 88 of the cartridge 30, thereby holding and flanging it in place.

The annular cartridge can then be bonded in abradable material. The casing 14 is heated, for example to a temperature of between 25 and 300° C., and preferably between 80 and 200° C. This operation can be realized during a cycle lasting between 60 and 500 minutes, and preferably between 180 and 300 minutes.

At the end of the heating operation, the temperature to which the casing 14 is subjected is lowered. Once the casing 14 has cooled completely, the abradable layer 30 is bonded and fixed to the envelope 16.

From an industrial point of view, the invention has the advantage of improving the manufacture (repeatability, robustness) and assembly of the casing and also its three-dimensional control, as the positioning of the annular layer of abradable material is guaranteed by the molded axial abutment means. The invention thus allows to improve the mechanical and aerodynamic performance of the casing, as well as its manufacturing method and overall cycle time.

The invention therefore allows to simplify manufacturing operations for a fan casing 16. It therefore allows to have a dual-flow aircraft turbine engine comprising a fan casing manufactured using the manufacturing method described above, thereby reducing the overall manufacturing costs.

1. A method for manufacturing a casing for an aircraft turbine engine, the method comprising:
a first step (ET1) of manufacturing an annular envelope extending around an axis A and comprising at least one intermediate section configured to receive an annular cartridge made of an abradable material, during which an annular preform of axis A of the envelope, made of a composite material comprising three-dimensionally woven fibers, is placed in a mold that comprises an annular cavity configured to complementarily receive the preform, then during which a resin is injected into said cavity and the resin is subsequently polymerized,
a second step (ET2) during which at least one axial abutment means is arranged projecting from a first internal annular surface of the intermediate section of the envelope, at a first end of said intermediate section,
a third step (ET3) during which the annular cartridge is arranged inside the annular envelope in contact with said axial abutment means, covering said first annular surface,
a fourth step (ET4) of bonding the annular cartridge to the first internal annular surface, during which the casing is heated and held by means of a system present at least in part inside the casing,
wherein the second step (ET2) takes place simultaneously with the first step (ET1), and during said second step (ET2), said at least one axial abutment means is molded with the preform in the mold.

2. The manufacturing method according to claim 1, wherein the axial abutment means molded with the preform is in the form of an annular bead of axis A.

3. The manufacturing method according to claim 2, wherein the mold used during said first and second steps comprises an outer annular shell of axis A and an inner annular shell of axis A between which the cavity is delimited, and the inner shell comprises an annular groove of axis A which opens into the cavity and which is configured to be filled with resin when the resin is injected into the cavity, the resin forming said bead after polymerization of the resin and demolding.

4. The manufacturing method according to claim 1, wherein during the third step (ET3), the annular cartridge is flanged inside the envelope by means of at least one removable flanging device.

5. An annular envelope of axis A of a casing for a turbine engine molded by resin injection from an annular preform of 3-dimensionally woven fibers, the envelop comprising at least one annular intermediate section which is configured to receive an annular cartridge and of which a first internal annular surface comprises at least one axial abutment means which projects from said first internal annular surface and which is molded with the resin of said envelope.

6. The annular envelope according to claim 5, wherein the axial abutment means is an annular bead of axis A molded with the resin of the envelope.

7. The annular envelope according to claim 5, wherein the axial abutment means is an annular bead of axis A made entirely and solely from the resin of the envelope.

8. The annular envelope according to claim 6, wherein the bead has a thickness or radial dimension of between 10 and 30 mm and/or a width or axial dimension of between 2 and 3 mm.

9. A mold for manufacturing annular envelope of a casing for the turbine engine according to claim 7, the mold comprising an outer annular shell of axis A with an inner annular recess and an inner annular shell of axis A with an outer annular recess, said recesses delimiting a cavity of the mold, said shells being configured to be arranged respectively outside and inside a preform so that the cavity receives the preform and is filled with resin by injection, wherein an intermediate section of the inner shell comprises an annular groove of axis A formed in the outer annular recess and configured to be filled with resin.

10. A dual-flow aircraft turbine engine comprising a fan casing manufactured according to the manufacturing method of claim 1.
